(19) United States
(12) Patent Application Publication
(10) Pub. No.: US 2021/0347147 A1
(43) Pub. Date: Nov. 11, 2021

(54) LAMINATED FOAM COMPOSITE BACKER BOARD FOR WET SPACE CONSTRUCTION, AND METHOD FOR MAKING THE SAME

(71) Applicant: Jaeger USA, Inc., Rochester, NH (US)

(72) Inventors: Jennifer M. Savinelli, Rochester, NH (US); John Simmers, Rochester, NH (US)

(21) Appl. No.: 17/314,426

(22) Filed: May 7, 2021

Related U.S. Application Data
(60) Provisional application No. 63/021,443, filed on May 7, 2020.

(51) Int. Cl. B32B 5/18; B32B 7/12; B32B 5/02; B32B 27/06; B32B 27/12; B32B 37/12; B32B 37/18; E04C 2/296; E04F 13/08; E04F 15/02

(52) U.S. Cl. CPC B32B 5/18; A47K 3/28; B32B 5/022; B32B 27/065; B32B 27/12; B32B 37/12; B32B 37/182; E04C 2/296; E04F 13/0875; E04F 15/02188; B32B 2266/08; B32B 2266/0228; B32B 2262/0253; B32B 2419/04; B32B 2255/205; B32B 7/12

(57) ABSTRACT

A laminated foam composite backer board comprising: a foam core; a first adhesive layer on each face of the foam core; a polymeric film layer on the outer face of each first adhesive layer; a second adhesive layer on the outer face of each polymeric film layer; and a non-woven fabric layer on the outer face of each second adhesive layer.

### REFERENCE TO PENDING PRIOR PATENT APPLICATION

This patent application claims benefit of pending prior U.S. Provisional Patent Application Ser. No. 63/021,443, filed May 7, 1920 by Jaeger USA, Inc. and Jennifer M. Savinelli for LAMINATED FOAM COMPOSITE BACKER BOARD FOR WET SPACE CONSTRUCTION, AND METHOD FOR MAKING THE SAME (Attorney's Docket No. JUSA-2 PROV), which patent application is hereby incorporated herein by reference.

### FIELD OF THE INVENTION

This invention relates to backer boards for wet space construction in general, and more particularly to laminated foam composite backer boards for wet space construction.

### BACKGROUND OF THE INVENTION

Backer boards are designed to sit between a building structural surface and a finish surface. Backer boards are used with both interior and exterior walls and floors, particularly in moisture-rich areas such as bathrooms, kitchens and other tiled areas.

Wet space construction seeks to prevent moisture from coming into contact with building structural surfaces (such as flooring substrates and wall substrates) so as to prevent mold from forming and rot from occurring.

In current wet space construction, tile or stone floors, walls and countertops are typically created by first placing a backer board over a wood subfloor or directly to wood or metal wall studs. See FIG. 1. The tile or stone finish layer is then applied to the backer boards.

Conventional backer boards include glass fiber mesh-reinforced cement backer boards, fiber cement backer boards, fiber-reinforced water-resistant gypsum backer boards, etc. Conventional backer boards are permeable to moisture, thereby requiring the installation of a waterproofing membrane between the backer board and the tile or stone finish layer. Such conventional backer boards are heavy and difficult to cut, thus requiring a high degree of trade knowledge, skill, and time to properly install. In addition, such conventional backer boards frequently contain materials which, when the backer boards are cut, present a hazard to the construction worker. As a result, significant care must be taken to control the debris created during cutting, including the wearing of face masks, etc.

Manufacturers have developed polymer foam backer boards in order to provide a cost-effective alternative to applying waterproofing membranes over conventional backer boards. However, polymer foam backer boards by themselves typically lack the necessary strength and stiffness to support a tile or stone application, and thus they require an additional structure or “facer” to be applied to the surface(s) of the polymer foam backer boards. The outer surfaces of these facer(s) typically have some kind of coating or additional material applied to them so as to provide a mortar-bondable surface for tile or stone adhesion. Several different materials, or combinations of materials, have been used for these facers. The three most prevalent materials used for these facers are paper (with a mortar-bondable fabric), glass-fiber mesh (with a mortar-bondable cementitious coating or coated glass mat), and polymeric film (with a mortar-bondable fabric).

Polymeric films offer many advantages for use as facers. For example, polymer films have a low water permeability, making the polymer films suitable for steam room applications without additional low-permeability waterproofing membranes/vapor barriers and, because polymeric films do not contribute to the growth of mold or mildew, they are ideal for use in wet space construction.

Polymeric films are, however, inherently difficult to adhesively bond to other materials. Therefore, manufacturers typically place a fabric layer on both sides of the polymeric film layer. The fabric layer can comprise a woven fabric or a non-woven fabric. Thus, with the provision of a fabric layer on both faces of every polymeric film layer, the issue of adhesion between the polymeric films and other materials can be addressed. Unfortunately, this multi-layer construction (with a fabric layer on both sides of each polymer film layer) increases costs and processing times of the polymer foam backer boards.

Therefore, a need exists for a new and improved laminated foam composite backer board that is cheaper to manufacture and can be more easily and reliably manufactured.

### SUMMARY OF THE INVENTION

These and other objects of the present invention are addressed by the provision and use of a novel laminated foam composite backer board for wet space construction.

The novel laminated foam composite backer board of the present invention is cheaper to manufacture and provides for easier and more reliable manufacturing.

In a preferred form of the invention, the novel laminated foam composite backer board of the present invention generally comprises:

a foam core;

a first adhesive layer on each face of the foam core;

a polymeric film layer on the outer face of each first adhesive layer;

a second adhesive layer on the outer face of each polymeric film layer; and

a non-woven fabric layer on the outer face of each second adhesive layer.

Thus, in a preferred form of the invention, the novel laminated foam composite backer board of the present invention generally comprises a foam core, two first adhesive layers, two polymeric film layers, two second adhesive layers and two non-woven fabric layers.

It will be appreciated that the foam core, the first adhesive layers, the polymeric film layers, the second adhesive layers, and the non-woven fabric layers are bonded together so as to form a singular composite structure, i.e., the laminated foam composite backer board.

In use, the novel laminated foam composite backer board is secured to a wood subfloor or to wood or metal wall studs using thin set mortar (or other suitable bonding material), and then the tile or stone finish layer is secured to the novel laminated foam composite backer board using thin set mortar (or other suitable bonding material).

Additional novel constructions are also disclosed below.

In one preferred form of the invention, there is provided a laminated foam composite backer board comprising:

a foam core;

a first adhesive layer on each face of the foam core;

a polymeric film layer on the outer face of each first adhesive layer;

a second adhesive layer on the outer face of each polymeric film layer; and

a non-woven fabric layer on the outer face of each second adhesive layer.

In another preferred form of the invention, there is provided a method for making a laminated foam composite backer board, the method comprising:

providing a foam core;

applying a first adhesive layer on each face of the foam core;

applying a polymeric film layer on the outer face of each first adhesive layer;

applying a second adhesive layer on the outer face of each polymeric film layer; and

applying a non-woven fabric layer on the outer face of each second adhesive layer.

In another preferred form of the invention, there is provided a method for forming a wet space construction, the method comprising:

providing a laminated foam composite backer board comprising:
a foam core;
a first adhesive layer on each face of the foam core;
a polymeric film layer on the outer face of each first adhesive layer;
a second adhesive layer on the outer face of each polymeric film layer; and
a non-woven fabric layer on the outer face of each second adhesive layer;

securing the laminated foam composite backer board to a building structural surface by securing the outer surface of one of the non-woven fabric layers to the building structural surface; and

securing a tile or stone finish layer to the outer surface of the other non-woven fabric layer.

In another preferred form of the invention, there is provided a laminated foam composite backer board comprising:

a foam core;

a first adhesive layer on each face of the foam core;

a polymeric film layer on the outer face of each first adhesive layer;

a second adhesive layer on the outer face of one of the polymeric film layers; and

a non-woven fabric layer on the outer face of the second adhesive layer.

In another preferred form of the invention, there is provided a laminated foam composite backer board comprising:

a foam core;

a first adhesive layer on each face of the foam core;

a polymeric film layer on the outer face of one first adhesive layers;

a metalized film layer on the outer face of the other first adhesive layer;

a second adhesive layer on the outer face of the polymeric film layer; and

a non-woven fabric layer on the outer face of the second adhesive layer.

### BRIEF DESCRIPTION OF THE DRAWINGS

These and other objects and features of the present invention will be more fully disclosed or rendered obvious by the following detailed description of the preferred embodiments of the invention, which is to be considered together with the accompanying drawings wherein like numbers refer to like parts, and further wherein:

FIG. 1 is a schematic view showing a wall shower assembly or wet space and illustrating how backer boards are positioned between a building structural surface and a finish surface;

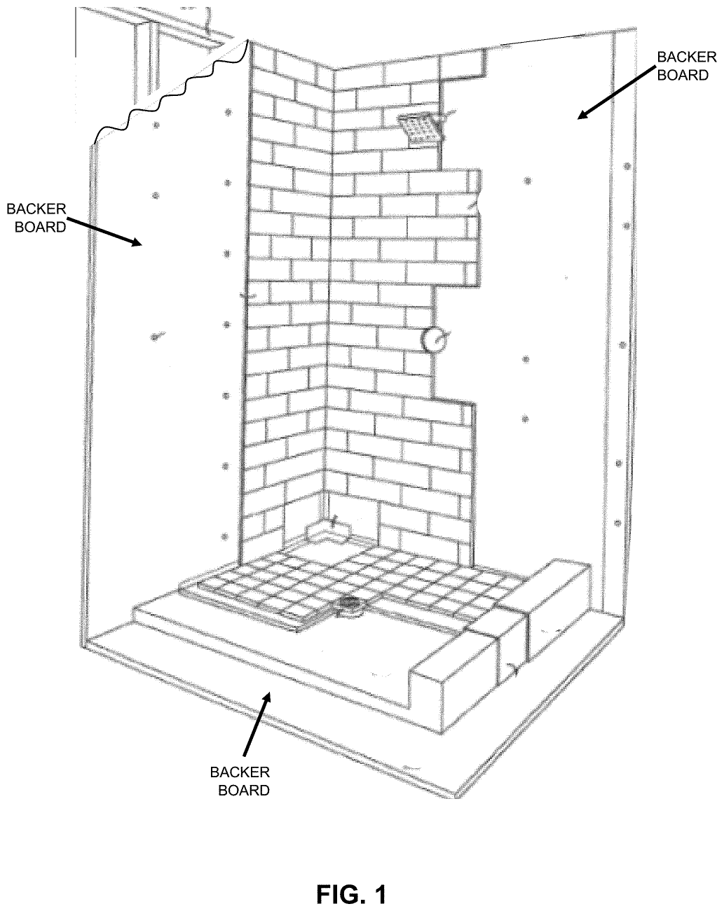

FIG. 2 is a schematic view showing a novel laminated foam composite backer board formed in accordance with the present invention;

FIG. 3 is a schematic view showing the novel laminated foam composite backer board of FIG. 2 in use;

FIG. 4 is a schematic view showing another novel laminated foam composite backer board formed in accordance with the present invention;

FIG. 5 is a schematic view showing the novel laminated foam composite backer board of FIG. 4 in use;

FIG. 6 is a schematic view showing still another novel laminated foam composite backer board formed in accordance with the present invention; and

FIG. 7 is a schematic view showing the novel laminated foam composite backer board of FIG. 6 in use.

### DETAILED DESCRIPTION OF THE INVENTION

The present invention comprises the provision and use of a novel laminated foam composite backer board for wet space construction.

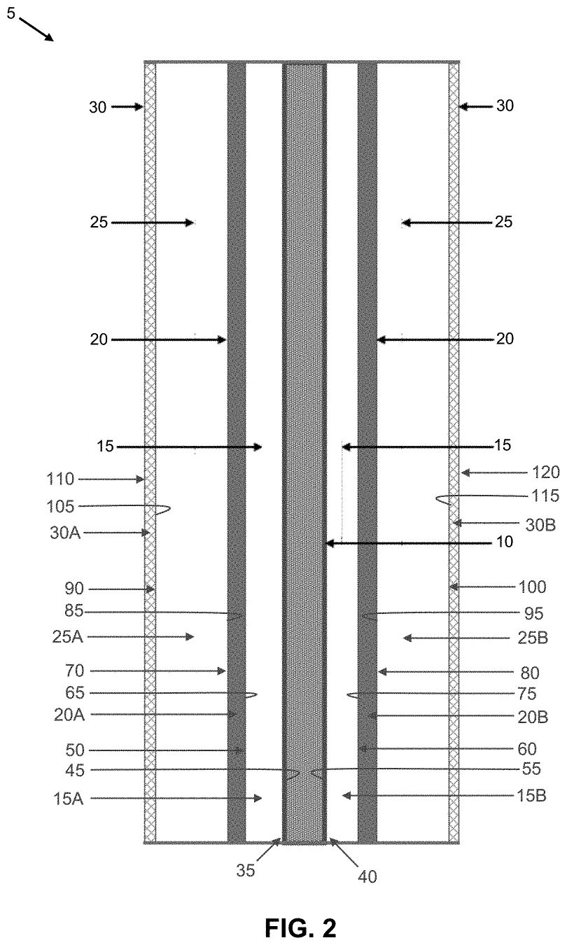

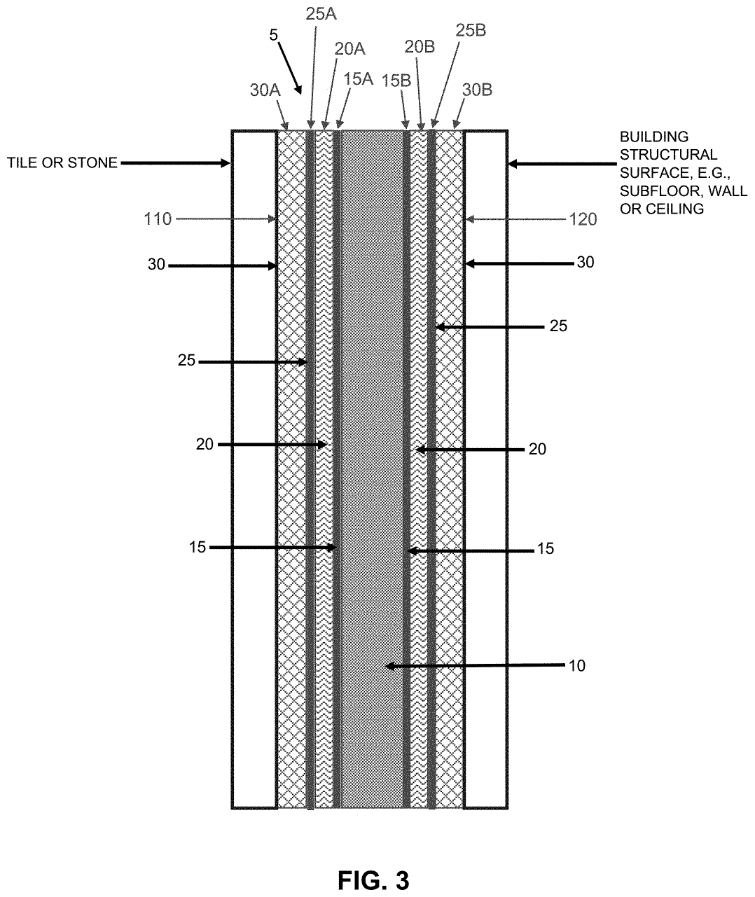

### Novel Laminated Foam Composite Backer Board with Two Non-Woven Fabric Layers (FIGS. 2 and 3)

In one preferred form of the invention, and looking now at FIGS. 2 and 3, there is provided a novel laminated foam composite backer board 5 which generally comprises a foam core 10, a first adhesive layer 15 on each face of foam core 10, a polymeric film layer 20 on the outer face of each first adhesive layer 15, a second adhesive layer 25 on the outer face of each polymeric film layer 20, and a non-woven fabric layer 30 on the outer face of each second adhesive layer 25.

More particularly, in the preferred form of the invention, there is provided a novel laminated foam composite backer board 5 which comprises:

a foam core 10 having an outer surface 35 and an outer surface 40;

a first adhesive layer 15A having an inner surface 45 and an outer surface 50, with the inner surface 45 of first adhesive layer 15A engaging and bonding to the outer surface 35 of foam core 10;

another first adhesive layer 15B having an inner surface 55 and an outer surface 60, with the inner surface 55 of first adhesive layer 15B engaging and bonding to the outer surface 40 of foam core 10;

a polymeric film layer 20A having an inner surface 65 and an outer surface 70, with the inner surface 65 of polymeric film layer 20A engaging and bonding to the outer surface 50 of first adhesive layer 15A;

a polymeric film layer 20B having an inner surface 75 and an outer surface 80, with the inner surface 75 of polymeric film layer 20B engaging and bonding to the outer surface 60 of first adhesive layer 15B;

a second adhesive layer 25A having an inner surface 85 and an outer surface 90, with the inner surface 85 of second adhesive layer 25A engaging and bonding to the outer surface 70 of polymeric film layer 20A;

another second adhesive layer 25B having an inner surface 95 and an outer surface 100, with the inner surface 95 of second adhesive layer 25B engaging and bonding to the outer surface 80 of polymeric film layer 20B;

a non-woven fabric layer 30A having an inner surface 105 and an outer surface 110, with the inner surface 105 of non-woven fabric layer 30A engaging and bonding to the outer surface 90 of second adhesive layer 25A; and

another non-woven fabric layer 30B having an inner surface 115 and an outer surface 120, with the inner surface 115 of non-woven fabric layer 30B engaging and bonding to the outer surface 100 of second adhesive layer 25B.

Thus, in this form of the invention, the novel laminated foam composite backer board 5 generally comprises a foam core 10, two first adhesive layers 15, two polymeric film layers 20, two second adhesive layers 25 and two non-woven fabric layers 30.

It will be appreciated that the foam core 10, the first adhesive layers 15, the polymeric film layers 20, the second adhesive layers 25, and the non-woven fabric layers 30 are bonded together so as to form a singular composite structure (i.e., the laminated foam composite backer board 5).

In one form of the invention, foam core 10 comprises a polystyrene having a closed-cell foam structure core.

In another form of the invention, foam core 10 may comprise extruded polystyrene (XPS) foam, expanded polystyrene (EPS) foam, polyethylene-terephthalate (PET) foam, polyisocyanurate (ISO) foam, etc.

In one form of the invention, first adhesive layers 15 comprise a polymeric adhesive which is able to adhere to both foam core 10 and polymeric film layers 20.

By way of example but not limitation, first adhesive layers 15 may comprise a thin hot melt adhesive, an epoxy adhesive, or a polyisobutylene (PIB) adhesive.

By way of further example but not limitation, first adhesive layers 15 may comprise any polymeric adhesives useful with plastic films and foams, such as polyolefin copolymers such as ethylene/vinyl acetate, ethylene/acrylic acid, ethylene/n-butyl acrylate, ethylene/methylacrylate, ethylene ionomers, and ethylene or propylene graft anhydrides, urethanes, copolyesters and copolyamides, styrene block copolymers such as styrene/butadiene and styrene/isoprene polymers, acrylic polymers, and the like.

In one form of the invention, polymeric film layers 20 may comprise a thermoplastic or thermosetting material.

By way of example but not limitation, polymeric film layers 20 may comprise polystyrene, polyolefins, alkenyl aromatic polymers, polyesters, polycarbonates, and acrylic or polyamide polymers. Useful polyolefins include polyethylene and polypropylene. Useful polyethylenes include high density polyethylene, low density polyethylene, and linear low density polyethylene.

If desired, the surfaces of polymeric film layers 20 may be roughened for improved adhesion.

It should be appreciated that polymeric film layers 20 are water impermeable and do not contribute to the growth of mold or mildew.

In one form of the invention, second adhesive layers 25 comprise a polymeric adhesive which is able to adhere to both polymeric film layers 20 and non-woven fabric layers 30.

By way of example but not limitation, second adhesive layers 25 may comprise a thin hot melt adhesive, an epoxy adhesive, or a polyisobutylene (PIB) adhesive.

By way of further example but not limitation, second adhesive layers 25 may comprise any polymeric adhesives useful with plastic films and foams, such as polyolefin copolymers such as ethylene/vinyl acetate, ethylene/acrylic acid, ethylene/n-butyl acrylate, ethylene/methylacrylate, ethylene ionomers, and ethylene or propylene graft anhydrides, urethanes, copolyesters and copolyamides, styrene block copolymers such as styrene/butadiene and styrene/isoprene polymers, acrylic polymers, and the like.

In one form of the invention, non-woven fabric layers 30 may comprise textile structures which are formed out of individual fibers or threads and which are bondable to thin set mortar (or another suitable bonding material).

In one preferred form of the invention, non-woven fabric layers 30 comprise a polyolefin-based non-woven fabric.

It will be appreciated that foam core 10, first adhesive layers 15, polymeric film layers 20, second adhesive layers 25, and non-woven fabric layers 30 are bonded together so as to form a singular composite structure (i.e., the laminated foam composite backer board 5).

It will also be appreciated that due to this construction (with a fabric layer on only one side of each polymer film layer), the novel laminated foam composite backer board of the present invention is cheaper and easier to manufacture than currently available laminated foam composite backer boards.

In use, and looking now at FIG. 3, novel laminated foam composite backer board 5 is secured to a wood subfloor or to wood or metal wall studs using thin set mortar (or other suitable building material), e.g., outer surface 120 of non-woven fabric layer 30B is secured to a wood subfloor or to wood or metal wall studs using thin set mortar (or other suitable material); and then the tile or stone finish layer is secured to novel laminated foam composite backer board 5 using thin set mortar (or other suitable boarding material), e.g., the tile or stone finish layer is secured to outer surface 110 of non-woven fabric layer 30A.

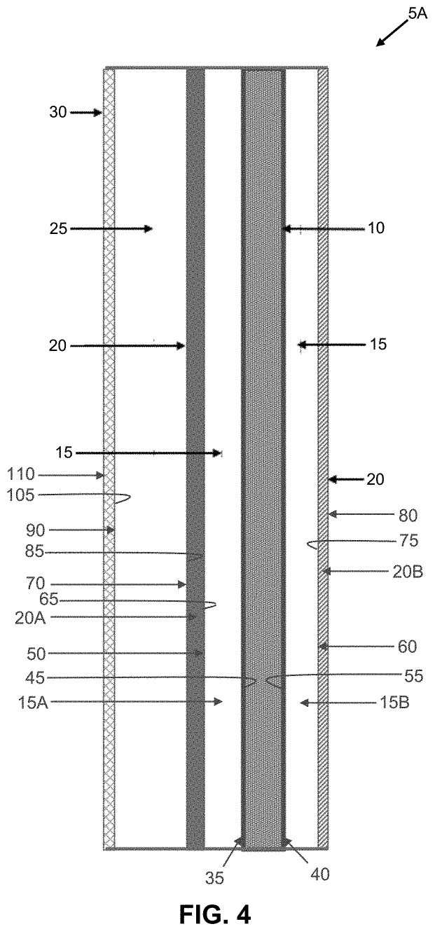

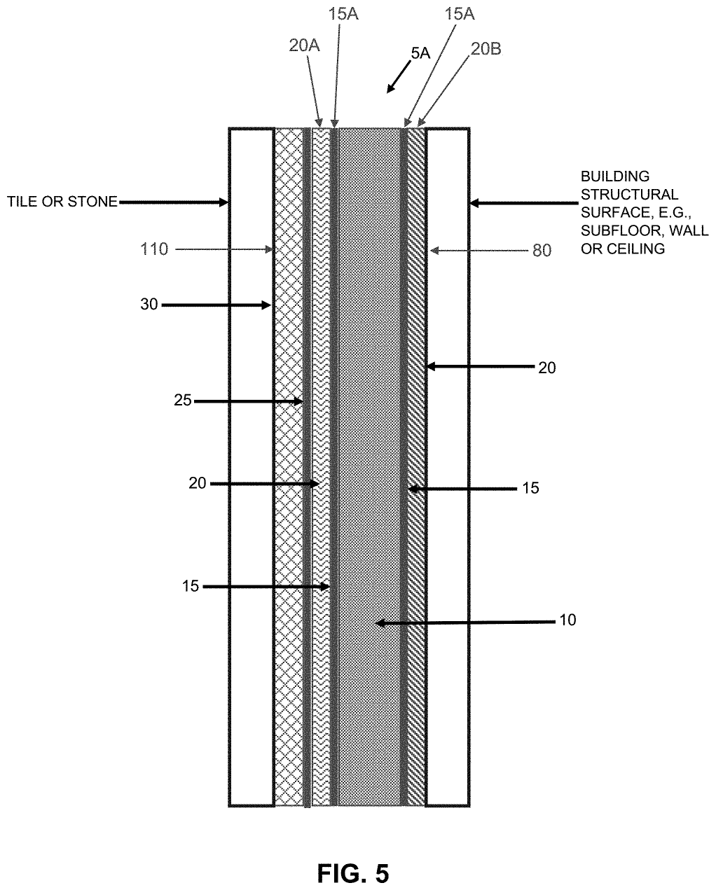

### Novel Laminated Foam Composite Backer Board with One Non-Woven Fabric Layer (FIGS. 4 and 5)

In another form of the invention, and looking now at FIGS. 4 and 5, there is provided a novel laminated foam composite backer board 5A which generally comprises a foam core 10, a first adhesive layer 15 on each face of foam core 10, a polymeric film layer 20 on the outer face of each first adhesive layer 15, a second adhesive layer 25 on the outer face of one of the polymeric film layers 20, and a non-woven fabric layer 30 on the outer face of the second adhesive layer 25.

More particularly, in this form of the invention, there is provided a novel laminated foam composite backer board 5A which comprises:

a foam core 10 having an outer surface 35 and an outer surface 40;

a first adhesive layer 15A having an inner surface 45 and an outer surface 50, with the inner surface 45 of first adhesive layer 15A engaging and bonding to the outer surface 35 of foam core 10;

another first adhesive layer 15B having an inner surface 55 and an outer surface 60, with the inner surface 55 of first adhesive layer 15B engaging and bonding to the outer surface 40 of foam core 10;

a polymeric film layer 20A having an inner surface 65 and an outer surface 70, with the inner surface 65 of polymeric film layer 20A engaging and bonding to the outer surface 50 of first adhesive layer 15A;

a polymeric film layer 20B having an inner surface 75 and an outer surface 80, with the inner surface 75 of polymeric film layer 20B engaging and bonding to the outer surface 60 of first adhesive layer 15B;

a second adhesive layer 25 having an inner surface 85 and an outer surface 90, with the inner surface 85 of second adhesive layer 25 engaging and bonding to the outer surface 70 of polymeric film layer 20A; and

a non-woven fabric layer 30 having an inner surface 105 and an outer surface 110, with the inner surface 105 of non-woven fabric layer 30 engaging and bonding to the outer surface 90 of second adhesive layer 25.

Thus, in this form of the invention, the novel laminated foam composite backer board 5A generally comprises a foam core 10, two first adhesive layers 15, two polymeric film layers 20, a second adhesive layer 25 and a non-woven fabric layer 30.

It will be appreciated that foam core 10, first adhesive layers 15, polymeric film layers 20, second adhesive layer 25, and non-woven fabric layer 30 are bonded together so as to form a singular composite structure (i.e., the laminated foam composite backer board 5A).

It will also be appreciated that polymeric film layers 20 may each comprise a different material, i.e., the polymeric film layer 20 with the non-woven fabric layer 30 adhered to it may comprise one material and the other polymeric film layer 20 may comprise a different material.

In use, and looking now at FIG. 5, polymeric film layer 20B of novel laminated foam composite backer board 5A is secured to a wood subfloor or to wood or metal wall studs using thin set mortar (or other suitable bonding material), e.g., outer surface 80 of polymeric film layer 20B is secured to a wood subfloor or to wood or metal wall studs using thin set mortar (or other suitable bonding material); and then the tile or stone finish layer is secured to non-woven fabric layer 30 of novel laminated foam composite backer board 5A using thin set mortar (or other suitable bonding material), e.g., the tile or stone finish layer is then secured to outer surface 110 of non-woven fabric layer 30.

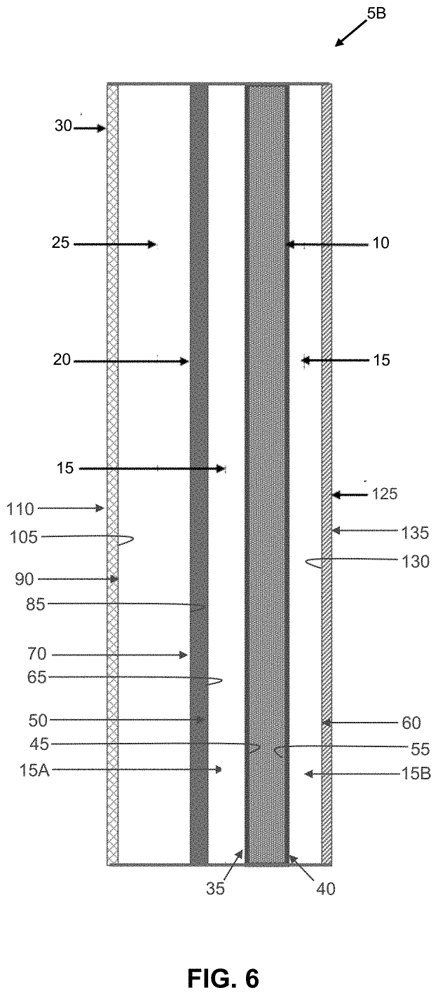

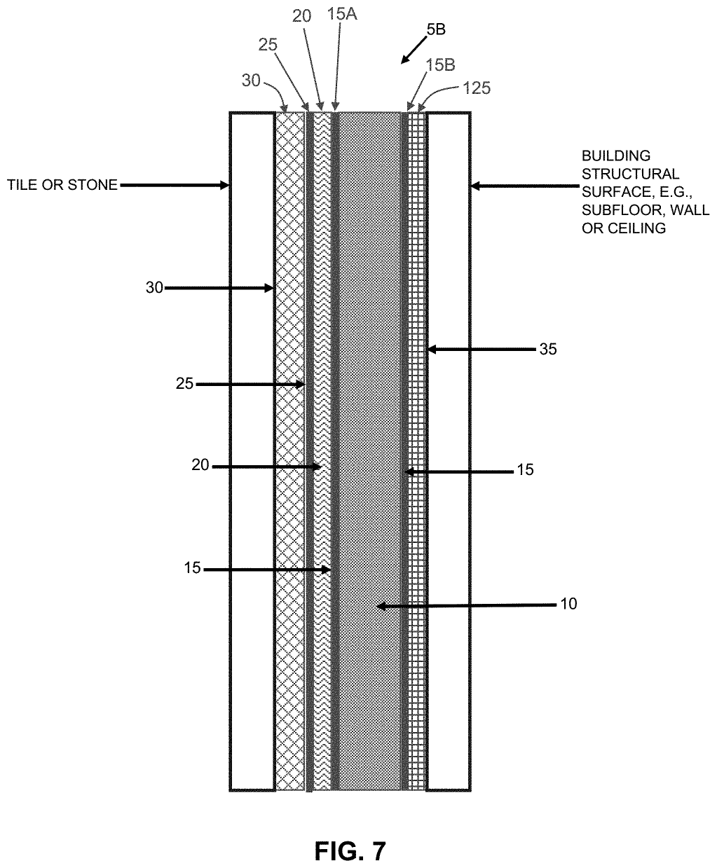

### Novel Laminated Foam Composite Backer Board with One Non-Woven Fabric Layer and a Metallized Film Layer (FIGS. 6 and 7)

In another form of the invention, and looking now at FIGS. 6 and 7, there is provided a novel laminated foam composite backer board 5B which generally comprises a foam core 10, a first adhesive layer 15 on each face of foam core 10, a polymeric film layer 20 on the outer face of one first adhesive layer 15, a metalized film layer 125 on the outer face of the other first adhesive layer 15, a second adhesive layer 25 on the outer face of polymeric film layer 20, and a non-woven fabric layer 30 on the outer face of the second adhesive layer 25.

More particularly, in this form of the invention, there is provided a novel laminated foam composite backer board 5B which comprises:

a foam core 10 having an outer surface 35 and an outer surface 40;

a first adhesive layer 15A having an inner surface 45 and an outer surface 50, with the inner surface 45 of first adhesive layer 15A engaging and bonding to the outer surface 35 of foam core 10;

another first adhesive layer 15B having an inner surface 55 and an outer surface 60, with the inner surface 55 of first adhesive layer 15B engaging and bonding to the outer surface 40 of foam core 10;

a polymeric film layer 20 having an inner surface 65 and an outer surface 70, with the inner surface 65 of polymeric film layer 20 engaging and bonding to the outer surface 50 of first adhesive layer 15A;

a metalized film layer 125 having an inner surface 130 and an outer surface 135, with the inner surface 130 of metalized film layer 125 engaging and bonding to the outer surface 60 of first adhesive layer 15B;

a second adhesive layer 25 having an inner surface 85 and an outer surface 90, with the inner surface 85 of second adhesive layer 25 engaging and bonding to the outer surface 70 of polymeric film layer 20; and

a non-woven fabric layer 30 having an inner surface 105 and an outer surface 110, with the inner surface 105 of non-woven fabric layer 30 engaging and bonding to the outer surface 90 of second adhesive layer 25.

Thus, in this form of the invention, the novel laminated foam composite backer board 5B generally comprises a foam core 10, two first adhesive layers 15, a polymeric film layer 20, a metalized film layer 125, a second adhesive layer 25 and a non-woven fabric layer 30.

In one form of the invention, metalized film layer 125 comprises aluminum, nickel or chromium.

By way of example but not limitation, metalized film layer 125 may comprise an aluminum laminated metallized polyester film.

It will be appreciated that foam core 10, first adhesive layers 15, polymeric film layer 20, metalized film layer 125, second adhesive layer 25, and non-woven fabric layer 30 are bonded together so as to form a singular composite structure (i.e., the laminated foam composite backer board 5B).

In use, and looking now to FIG. 7, metalized film layer 125 of novel laminated foam composite backer board 5B is secured to a wood subfloor or to wood or metal wall studs using thin set mortar (or other suitable bonding material), e.g., outer surface 135 of metalized film layer 125 is secured to a wood subfloor or to wood or metal wall studs using thin set mortar (or other suitable material); and then the tile or stone finish layer is secured to non-woven fabric layer 30 of novel laminated foam composite backer board 5B using thin set mortar (or other suitable bonding material), e.g., the tile or stone finish layer is then secured to outer surface 110 of non-woven fabric layer 30.

### Additional Notes Re the Constructions

It should be appreciated that the relative thicknesses of the various components may vary from construction to construction and also within specific constructions. Thus, for example, the relative thicknesses of foam core 10, first adhesive layers 15, polymeric film layers 20, second adhesive layers 25, non-woven fabric layers 30, metalized film layer 125, the building structural surfaces and/or the tile or stone surfaces, etc. may vary from construction to construction and also within specific constructions.

Furthermore, where a single construction comprises two layers of a similar nature (e.g., two first adhesive layers 15, and/or two polymeric film layers 20, and/or two second adhesive layers 25, and/or two non-woven fabric layers 30, etc.), one of those layers may comprise a first composition and/or thickness and the other of those layers may comprise a second composition and/or thickness. By way of example but not limitation, where a single construction comprises two first adhesive layers 15 (e.g., first adhesive layer 15A and first adhesive layer 15B), one of the first adhesive layers 15 (e.g., first adhesive layer 15A) might comprise a first material and first thickness, and the other of the adhesive layers (e.g., first adhesive layer 15B) might comprise a second material and second thickness, and the first material may be the same as or different from the second material, and the first dimension may be the same as or different from the second dimension.

### Additional Notes Re the Figures

It should also be appreciated that the figures are intended to be schematic in nature and not necessarily to scale, and the visual representations of relative thicknesses of the various components are not intended to be interpreted literally.

Thus, for example, in FIGS. 2-7, the visual representations of the relative thicknesses of foam core 10, first adhesive layers 15, polymeric film layers 20, second adhesive layers 25, non-woven fabric layers 30, metalized film layer 125, the building structural surfaces and/or the tile or stone surfaces, etc. are not intended to represent the actual relative thicknesses of foam core 10, first adhesive layers 15, polymeric film layers 20, second adhesive layers 25, non-woven fabric layers 30, metalized film layer 125, the building structural surfaces and/or the tile or stone surfaces, etc. In some cases the visual representations of the relative thicknesses of certain layers may be exaggerated somewhat to simplify the illustration of a particular layer and/or to highlight the construction of a particular layer.

Furthermore, where several of the figures are described as showing the same specific construction (e.g., FIGS. 2 and 3; FIGS. 4 and 5; and FIGS. 6 and 7), the visual representations of the relative thicknesses of the various components are not necessarily shown consistently between the two figures. In some cases the visual representations of the relative thicknesses of certain layers may be exaggerated somewhat to simplify the illustration of a particular layer and/or to highlight the construction of a particular layer. Thus, for example, the visual representations of the relative thicknesses of the various components of FIG. 2 may different from the visual representations of the relative thicknesses of the various components of FIG. 3.

### MODIFICATIONS

It should be understood that many additional changes in the details, materials, steps and arrangements of parts, which have been herein described and illustrated in order to explain the nature of the present invention, may be made by those skilled in the art while still remaining within the principles and scope of the invention.

What is claimed is:

1. A laminated foam composite backer board comprising:
a foam core;
a first adhesive layer on each face of the foam core;
a polymeric film layer on the outer face of each first adhesive layer;
a second adhesive layer on the outer face of each polymeric film layer; and
a non-woven fabric layer on the outer face of each second adhesive layer.

2. A laminated foam composite backer board according to claim 1 wherein the foam core comprises a polystyrene having a closed-cell foam structure core.

3. A laminated foam composite backer board according to claim 1 wherein the foam core comprises one from the group consisting of extruded polystyrene (XPS) foam, expanded polystyrene (EPS) foam, polyethylene-terephthalate (PET) foam, and polyisocyanurate (ISO) foam.

4. A laminated foam composite backer board according to claim 1 wherein the first adhesive layers comprise a polymeric adhesive which is able to adhere to both the foam core and the polymeric film layers.

5. A laminated foam composite backer board according to claim 1 wherein the first adhesive layers comprise one from the group consisting of a thin hot melt adhesive, an epoxy adhesive, and a polyisobutylene (PIB) adhesive.

6. A laminated foam composite backer board according to claim 1 wherein the first adhesive layers comprise one from the group consisting of polyolefin copolymers, urethanes, copolyesters and copolyamides, styrene block copolymers and acrylic polymers.

7. A laminated foam composite backer board according to claim 1 wherein the polymeric film layers comprise one from the group consisting of a thermoplastic material and a thermosetting material.

8. A laminated foam composite backer board according to claim 1 wherein the polymeric film layers are water impermeable and do not contribute to the grow of mold or mildew.

9. A laminated foam composite backer board according to claim 1 wherein the polymeric film layers comprise one from the group consisting of polystyrene, polyolefins, alkenyl aromatic polymers, polyesters, polycarbonates, and acrylic or polyamide polymers.

10. A laminated foam composite backer board according to claim 1 wherein at least one surface of the polymeric film layers are roughened for improved adhesion.

11. A laminated foam composite backer board according to claim 1 wherein the second adhesive layers comprise a polymeric adhesive which is able to adhere to both the polymeric film layers and the non-woven fabric layers.

12. A laminated foam composite backer board according to claim 1 wherein the second adhesive layers comprise one from the group consisting of a thin hot melt adhesive, an epoxy adhesive, and a polyisobutylene (PIB) adhesive.

13. A laminated foam composite backer board according to claim 1 wherein the second adhesive layers comprise one from the group consisting of polyolefin copolymers, urethanes, copolyesters and copolyamides, styrene block copolymers and acrylic polymers.

14. A laminated foam composite backer board according to claim 1 wherein the non-woven fabric layers comprise textile structures which are formed out of individual fibers or threads and which are bondable to thin set mortar.

15. A laminated foam composite backer board according to claim 1 wherein the non-woven fabric layers comprise a polyolefin-based non-woven fabric.

16. Method for making a laminated foam composite backer board, the method comprising:
providing a foam core;
applying a first adhesive layer on each face of the foam core;
applying a polymeric film layer on the outer face of each first adhesive layer;
applying a second adhesive layer on the outer face of each polymeric film layer; and
applying a non-woven fabric layer on the outer face of each second adhesive layer.

17. A method for forming a wet space construction, the method comprising:
providing a laminated foam composite backer board comprising:
a foam core;
a first adhesive layer on each face of the foam core;
a polymeric film layer on the outer face of each first adhesive layer;
a second adhesive layer on the outer face of each polymeric film layer; and
a non-woven fabric layer on the outer face of each second adhesive layer;
securing the laminated foam composite backer board to a building structural surface by securing the outer surface of one of the non-woven fabric layers to the building structural surface; and
securing a tile or stone finish layer to the outer surface of the other non-woven fabric layer.

18. A laminated foam composite backer board comprising:
a foam core;
a first adhesive layer on each face of the foam core;
a polymeric film layer on the outer face of each first adhesive layer;
a second adhesive layer on the outer face of one of the polymeric film layers; and
a non-woven fabric layer on the outer face of the second adhesive layer.

19. A laminated foam composite backer board comprising:
a foam core;
a first adhesive layer on each face of the foam core;
a polymeric film layer on the outer face of one first adhesive layers;
a metalized film layer on the outer face of the other first adhesive layer;
a second adhesive layer on the outer face of the polymeric film layer; and
a non-woven fabric layer on the outer face of the second adhesive layer.
